(19) United States
(12) Patent Application Publication
(10) Pub. No.: US 2017/0121924 A1
(43) Pub. Date: May 4, 2017

(54) WAVE-POWER PLANT

(71) Applicant: Harald ORJAVIK, VEVANG (NO)

(72) Inventor: Harald ORJAVIK, VEVANG (NO)

(21) Appl. No.: 15/318,982

(22) PCT Filed: Jun. 15, 2015
(86) PCT No.: PCT/NO2015/000013

§ 371 Date: Dec. 15, 2016

(30) Foreign Application Priority Data
Jun. 17, 2014 (NO) 20140762
Jun. 15, 2015 (NO) 20150775

(51) Int. Cl. E02B 9/08; F03B 13/14; F03B 13/22

(52) U.S. Cl. CPC E02B 9/08; F03B 13/22; F03B 13/145

(57) ABSTRACT

Wave-power plant where the waves are guiding water into a basin, and where power is produced when water flows back into the sea through a turbine. The basin exhibits a bottom (4) positioned at least several typical wave heights down into the water, a rear wall (3), two side walls (2), a front wall (1) fronting the waves, and for larger plants, at least one partition wall (5) dividing the basins into several smaller basins. The front wall (1) and one or more division walls (5) are covered by apertures provided with check-valves (6) to allow through flow toward rear basin (14) providing water to at least one turbine (8). The basin can rest with its bottom (4) directly upon the seabed (13), and in deeper waters, above the seabed with the bottom (4) of the basin also being covered by apertures exhibiting check valves (6) for flow into the basin.

The invention concerns a wave power plant where the waves bring water into a basin and which produces power when the water streams back to the sea through a turbine.

It has been proposed plants with openings with check valves near the sea level on the side of the basin which are turned against the waves. When a wave go fast forward the water particles moves only local, slowly and very little compared to the wave length. The water must therefore consume a lot of it's energy in order to enter the basin. Because the water have to move a rather long distance compared to the height of fall from the wave to the level in the basin which is of short duration when the wave is up before the basin, there will be very little water which have time enough to stream into the basin. A little wave which comes after a big one will often lack the height to move water into the basin.

By the invention we avoid the uneven power and the regulation problems which we have with devices based on floating bodies, bottom hinged plates or walls and water columns which the waves move, where there are very difficult to guide these movements in relation to the waves so that the devices can be effective. It is difficult to make these devices big enough to fit that the wave power is shattered over large areas.

With wave power plants according to the invention the waves transmit their energy efficient into the basin by big and small waves and tides, and in the basin the kinetic energy too get transformed into potential energy for utilization in the turbine. The devices are suited for big capacities and can give a rather smooth power. With big waves the power output and the loads are reduced so that the device can survive and produce power with big waves. The devices are suited too for mounting in deep water in wave power parks.

That can be obtained according to the invention by that the basin have the bottom several wave heights down in the water, a back wall, to side walls, a front wall against the waves and one or preferably more division walls which divide the basin into more smaller basins. The front wall and the division walls are covered with openings with check valves for trough-put in the wave direction against the back basin which give water to at least one turbine. The basin is so deep and the check valves openings so great that the waves goes directly into the basin nearly in it's natural way with comparatively slow motion of the water particles and by that with small losses until they get stopped of the back wall and leave a slope water surface trough the basins.

The check valves in the walls lock the slope water surface when it is highest and prevent waves in the basins which could disturb the turbine and spill energy. At least one turbine gets water from the back basin and water from the basins before trough the openings with check valves in the division walls gradually as the level in the back basin taps down to under the levels in the basins before. When the waves press the water surface up and get stopped the kinetic energy too, which make up 50% of the wave energy, get transformed into potential energy which can be used in the turbine. When it is not too deep the basin can stand directly on the sea floor. At deeper water the basin can be placed above the sea floor and have the bottom too covered with openings with check valves. The device can be placed on a construction or mounted floating. Near the shore the wave direction are stable against the shore. Longer from the shore where the wave direction can change a lot the devices must be turned against the waves. Tidal variation in the sea level can be managed by making the walls with necessary height for high tide. In order to guide waves which are moving aslant against the device it can be mounted one or more closed walls from the front wall and trough at least one basin. With big devices with the basin placed above the sea floor, the closed walls can go from the front wall and quite to the back basin so that the valves in the bottom in one, more, possibly every other spaces this walls form, can be kept open for unloading the construction with water filled over the basin with big waves. Water which are brought into the other spaces where the valves in the bottom are closed will as normal stream to the back basin and further to the turbine so that the device can operate with big waves. The check valves in the bottom can be kept open by means of floats when the basin are overfilled and locked in a certain order so that chock can be avoided.The walls with openings with check valves are protected against big waves. They can be protected better by keeping the valves open. In order to protect the back wall against big waves, especially with fixed mounted devices, it can be equipped with hatches in rows over each other which can open and close after need. Since the hatches are placed in rows at different heights they can too be used to regulate the maximum height of the water surface in the basin with tides. The length of the basin ought to be adapted to the length of the typical waves which shall be harvested. By short basins placed above the sea floor, the back wall can be prolonged beneath the basin in order to increase the power output and to protect the turbine outlet against the waves. In order to get a more smooth power it can be used a bigger basin by making it longer. The big depth of the basin gives good condition for the streaming to the turbine. For big devices with great breadth it can be used division walls with openings with check valves in the back basin on each side of the turbine or turbines so that they can't be disturbed of waves in the back basin. Standing waves in the back basin can too be prevented by walls crosswise which are so low that the water can stream over the walls and further to the turbines. That can be obtained by that the close walls from the front wall to the back basin are prolonged through the back basin to the back wall with about half height. To prevent trash in the sea from entering the device it can be placed net or netting before the front wall against the waves and alternatively beneath the basin with devices above the sea floor. When the waves by storm can go over the basin it can be covered with netting or grates to walk on. In order to ease the mounting and service of the check valves they can be mounted in frames with a lot of openings with check valves. The frames can be mounted from the top of the walls by pushing them between to guidances from the top to the bottom. In deeper water the devices can be mounted floating with floats under the water with taunt anchor cables which keep the device in right height. Special anchor cables can turn the device against the waves. Alternatively the device can be turned against the waves by at least one horizontal wing with the axis pointing to the centre of the device which have a changing operating angle when the water moves up and down in the waves. The device can be turned in the opposite direction by turning the wing 180 degree around his axis or by moving the axis in the wing. The outlet from the turbine can be protected against the waves by flowing out behind the device and better if it goes to a basin or chamber which are drained trough great areas covered with openings with check valves and which have cross walls inside covered with openings with check valves for streaming away from the turbine. With fixed devices they can be emptied so much that the devices can produce power by smaller waves. With floating devices which have stabilizing plates in the depth, the turbine's outlet goes to chambers placed on the sides and behind the device between robust floats in the corners. The device can be mounted rotatable on a tower too.

The invention are getting explained in detail by means of preferred performances and mounting systems with reference to enclosed drawings where:

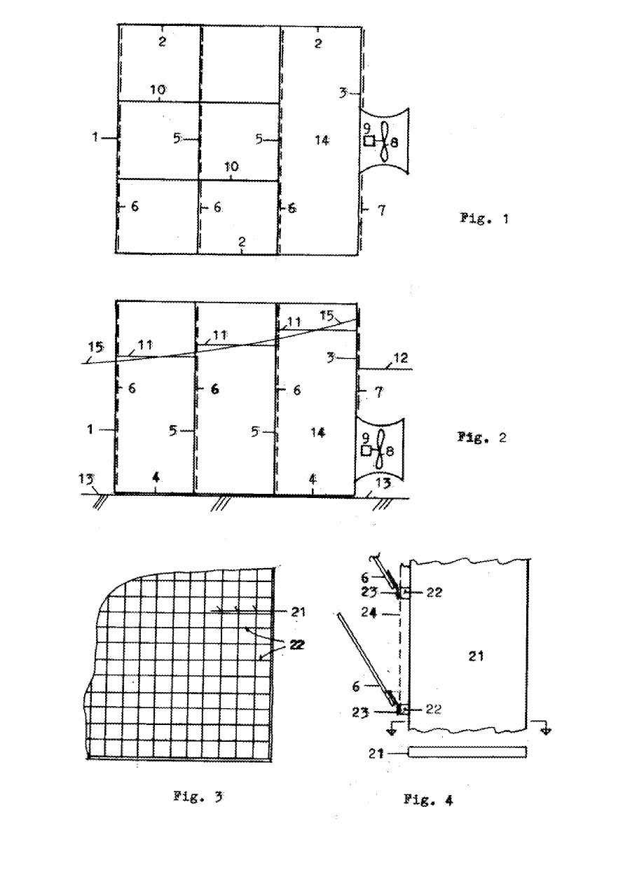

FIGS. 1 and 2 show plan and cut of a device which stands with the basin right on the sea floor.

FIGS. 3 and 4 show a frame with opening for check valves and detail of a valve.

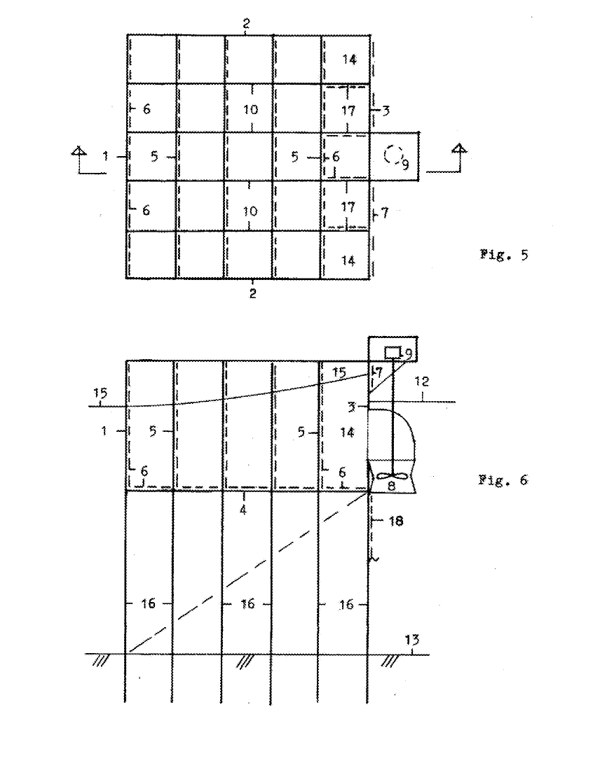

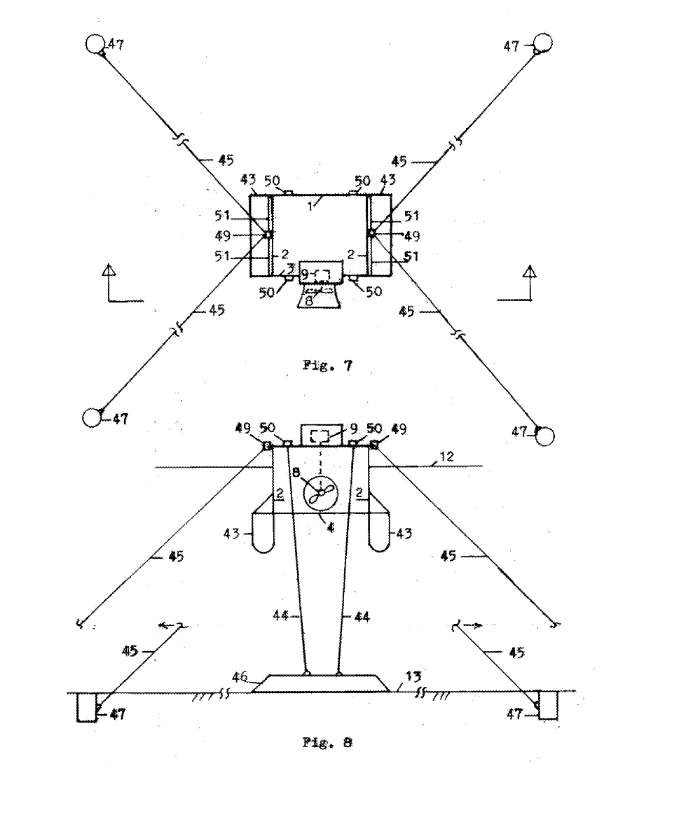

FIGS. 5 and 6 show plan and cut of a device mounted above the sea floor.

FIGS. 7 and 8 show plan and cut of a floating device with taunt anchor cables about parallel.

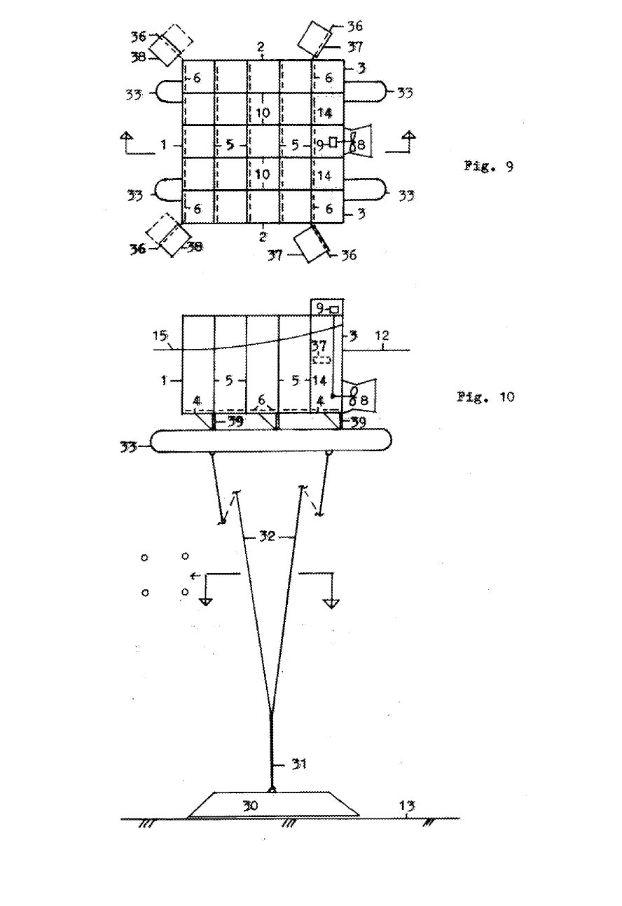

FIGS. 9 and 10 show plan and cut of a floating device where the anchor cables go together.

FIGS. 1 shows plan and FIG. 2 shows a cut in the wave direction of a device which stands on the sea floor. The basin is so deep that the waves can go directly into the basin nearly in it's natural way trough the front (1) which is covered with openings with check valves (6) and further trough the division walls (5) which too is covered with openings with check valves (6) until they get stopped of the back wall (3) with a slope water surface trough the basins. The check valves locks the water surface (15) when it is highest.

The height of fall are exploited well by that the turbine (8) get water from the back basin (14) with the highest height of fall first, and from the basins before as the water level in the back basin (14) taps down to under the levels in the basins before. It can possibly be used closed walls (10) from the front (1) through at least one basin for guiding waves which moves slanted to the basin. When the waves come one after another and goes into the device it is favourable that they have the characteristic so that waves with different heights, periods and direction only influence each, but otherwise are moving independently from each other so that they can go through each other. The higher water level (11) is in the device, the less water the waves bring into the basin in order to lave their energy. One can to some degree choose whether the turbine (8) operate with less water and greater height of fall or more water and less height of fall by choosing the draining of the basin. If it comes a little wave after a big one which lack the power to lift the water level in the back basin, it can leave it's energy in the basins before where the water levels are lower after a big wave. The walls which have openings with check valves are protected against big waves. The back wall (3) may have hatches (7) in rows at different heights which can open for unloading and open and close in rows in order to regulate the height of the back wall (3) by tidal variation in sea level. The outlet from the turbine are placed behind the back wall(3) to be protected against disturbance of the waves. It can be protected better by lengthening the side walls (2) behind the device or with broader devices. The devise can operate to cover a certain variable power demand or it can operate to produce as much power as possible.

FIG. 3 shows a frame with a lot of openings for check valves and FIG. 4 shows an opening with check valve (6) which is hinged on one side so that the opening are free by open valve. That the valves shall open easy and close quick with a little feather power, they are made small with little distance between hinge side an opposite side. That the frame with openings shall have great area for streaming, the bearing profiles (21) are thin and broad. In vertical walls (1 and 5) the profiles (21) can be vertical. The profiles (21) in the front wall (1) will then on a count of it's broadness guide the waves which moves slanted into the device. When the water shall into the basin it can be preferable that the valves are bottom hinged. If they are side hinged the valve movement will not be disturbed of the weight or variable weight of the valves which have a rather small feather power. In the bottom of the basin the bearing profiles (21) in the frames can be oriented in the wave direction and the valves be hinged by front edge. The valves (6) can be hinged with flat rubber (23) in order to be more robust against trash in the water. (24) are short profiles between the profiles (22) under the ends of two valves (6) and are preferably placed on the edge to the bearing profiles (21). The frames can be made of wood, plastic, aluminium or other materials.

FIG. 5 shows plan and FIG. 6 shows cut in the wave direction trough a device placed in deeper water above the sea floor (13) on stakes (16) and have the bottom too covered with openings with check valves (6) and have the back wall (3) in the basin with some lengthening (18) beneath the basin. Inside the basin it must be so deep that waves which go up in the forward part of the basin can go further to the back wall (3) in the basin. The closed walls (10) divide the basin between the front wall (1) and the forward wall (5) in the back basin (14) in several spaces. With big devices and big waves which can bring too much water into and probably over the device, the bottom valves (6) are kept open in one, more or every other space the walls (10) forms in order to unload the construction. Where the bottom valves (6) are open the device are unloaded at the same time as the water from above can stream down trough the open valves and contribute to maintain the pressure under the device so that the bottoms in intervals with closed valves get unloaded. Water which are brought into the spaces with closed valves in the bottom will then as normally be brought to the back basin (14) and further to the turbine (8) so that the device can operate by big waves.

FIGS. 7 and 8 show plan and cut of a wave power device with floats (43) beneath by the side walls (2) so that it can be towed easily to the mounting place and mounted floating with taunt anchor cables (44) from an anchor (46) to anchor fastening (50) on the wave power device which possibly can be equipped with winches. By mounting the anchor cables (44) are tightened so that the floats (43) came so deep in the water that the lift are not to much disturbed of the waves. The lift of the floats can be adjusted with ballast water. The anchor cables (44) can be used to adjust the height of the device with big tides. In order to turn the device against the waves it can be equipped with one rail (51) on each of two opposite sides on the device with fastenings (49) for anchor cables which can move opposite on the rails. Each of the fastening (49) are kept in place of two anchor cables (45) which goes to their own anchor (47) so that it became large angle between the anchor cables (45). If it is big tides so that the height of the device must be adjusted, the anchor cables (45) can go via buoys so that they goes more horizontal to the wave power device. In case the wave power device must be turned more than 90 degrees, the rails (51) could be circular and longer or possibly form a circle.

FIGS. 9 and 10 show respectively plan and cut of a wave power device mounted floating in deep water which can be turned against the waves. The side walls (2) and the walls (10) are formed to be beams which bear the device. They are beard of 3 bar joists (39) crosswise of the device which again rests on two long floats (33) oriented in the wave direction and placed under the device with a distance to each other. Since the movement of the water diminish exponential in the depth, the floats (33) are little disturbed of the waves.

If there are strong current from one side the floats can be turned 90 degree and the beams (39) can be cut out so that the side walls (2) and the walls (10) rest more directly on the floats (33). Each float (33) have at least two taunt anchor cables with one by each end which keep it under the water surface (12). The anchor cables (32) slope together to one anchor cable (31) at a certain distance above the anchor so that the device can be turned easier against the waves. When a horizontal force push the device away from the anchor (30) there will be a force from the slope anchor cables (31 and 32) with a horizontal component which will keep the device on place. The device is turning against the waves by means of a wing (37) on each side of the device which can rotate on an axle in the further part which is oriented against the centre of the device. When the water in the waves are moving up and down the wing (37) will have a changing angle and give a horizontal force. The forces from the two wings works against each other and equalize each other when the waves are straight on the device. When the waves comes slope to the device one of the wings (37) comes in lee and loose force when the other get more force by higher waves when they hit the side (2) of the device. If the device shall be turned more accurate against the waves there can be used one or more wings (38) placed more in the front against the waves and which are working together and guided of censors for wave direction. When the device shall be turned opposite the wings must be turned around 180 degree on it's shaft or the shaft may be displaced in the wing. The device can be turned against the waves with an electric motor with propel, but that consume energy. Since the device are not mounted rigid there are less stress with big waves. Because the bottom (4) in the device are covered with openings with check valves (6) the stress in the anchor cables (31 and 32) with big waves are for the most limited to the lift of the floats (33). If there comes a freak wave with a deep trough so that the device sink and the anchor cables (31 and 32) get slack, there will be a limited jerk when they get taunt again because the bottom (4) are covered with openings with check valves (6). The stress get relatively small because at the very moment that the anchor cables (31 and 32) get taunt the water level (12) have not yet got so high that the lift of the floats (33) have started to stress the anchor cables (31 and 32). The big floats (33) can keep the device above the water for easier transport and service. The anchor cables (31 and 32) can be mounted when they are slack by that the device get sunk down in the water by that the floats (33) are filled with enough water and that the device are kept floating by means of smaller floats at the top of the device. If there goes a control cable from the fastening on the anchor to the surface, the fastening of the cable (31) can be sunk down and fixed to the anchor without the use of divers. By adapting the length of the anchor cables (32) the device can be mounted slope for if desired to get more height at the back basin (14). The floats (33) can be supplemented or replaced of floats built into the lower parts of the side walls (2) and the closed walls (10).

FIGS. 11-14 show one check valve (6) which open and close quick so that it can be used bigger and fewer valves.

FIG. 11 shows cut through the valve (6) which has a curved plate (61) with two straight edges fixed to two opposite edge profiles (62) and (63) on a flat frame with tie bars (65) and possible cross walls in order to stiffen the curved plate (61). The valve body are by the rods (64) fixed on the axle (60). When the valve open and close the curved valve plate (61) move in or near a circle with the same radius. The valve are spring mounted to the rods (64) by the edge profile (62) by the spring (71) and possible by the edge profile (63) by the spring (72) so that the valve when it close stops with a little clearance to the valve seat and close completely when the pressure comes. If the valve stops with clearance on both sides one choose preferably most clearance by the edge profile (62). That entail that the curved valve plate (61) stand a little slope to a circle track with the centre in the axle so that the water can help both with opening and closing of the valve. The spring (71) by the edge profile (62) can be shortened of the water pressure so that the valve get more slope to a circle track with the centre in the axle (60) so that it can open more easy. The curved valve plate (61) can then lay in a circle and move in a circle track with centre in the axle.

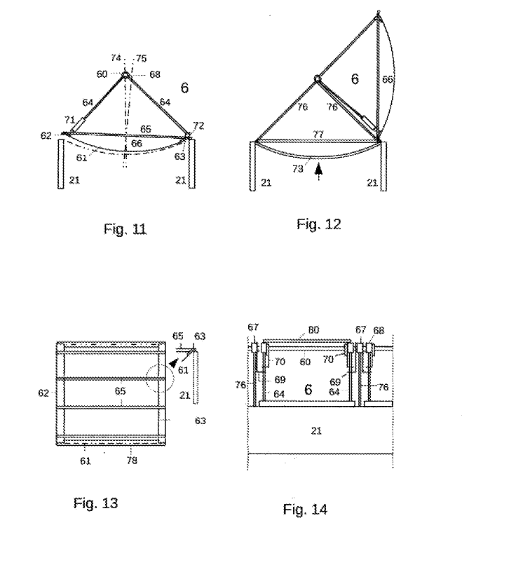

FIG. 12 shows a cut through an open valve. The curved profiles (73) is the valve seats for the ends of the curved valve body. The rods (77) keep the right distance between the profiles (21) where the edges are valve seats. The rods (76) carry the bearing houses (67) of the axle (60, FIG. 14).

FIG. 13 shows plan of the valve with extension (78) of rubber on the inside of the curved valve plate (61) which shall rest against the curved valve seat (73) in order to simplify production and to secure good tightening.

FIG. 14 shows valves mounted on a through shaft (60). A spring system (69) gives a closing force for the valve to rod (64) which bear the valve so that it can close quickly when the water stop streaming. (70) is a spring system stressed in advance and fixed on the axle (60) with a rod to the valve rods (64) in order to open the valve and to keep it in open position by turning the axle to position for open valve. The spring system (70) shall prevent damage when the valve have pressure and can not be opened before it is unloaded. One rod (80) close at least two rods (64) in each end of the valve to each other so that they rotate together around the axle (60). If the axle (60) is not used to keep the valve open, the rods (64) can be fixed mounted on the axle (60) and rod (80) leaved out. Each valve have then their own axle (60).

1. Wave power device where the waves bring water into a basin and which produce power when the water stream back to the sea through a turbine, characterized by that the basin has a bottom (4) at least more typically wave heights down in the water, a back wall (3), two side walls (2), a front wall (1) against the waves and with bigger devices from one to more division walls(5) which divide the basin in more smaller basins and that the front wall (1) and the division walls (5) are covered with openings with check valves (6) for streaming against the back basin (14) which gives water to at least one turbine (8) and that the basin can stand with the bottom (4) direct on the sea floor (13) and in deeper water above the sea floor with the bottom (4, FIG. 6) in the basin too covered with openings with check valves (6) for streaming into the basin.

2. Wave power device according to claim 1, characterized by that it with big devices with the basin placed above the sea floor go at least two closed walls (10, FIG. 5) from the front wall (1) entirely to the foremost wall (5) in the back basin (14) and possibly with half height through the back basin (14) to the back wall (3) and that the valves (6) in the bottom in one, more, every other or in all spaces these walls (10) form before the back basin (14) can be kept open.

3. Wave power device according to claim 1, characterized by that the back wall (3) of the basin and it's possible lengthening (18, FIG. 6) down below the basin has hatches in rows above each other.

4. Wave power device according to claim 1, characterized by that the openings with check valves are built into rectangular frames (FIG. 3) with more openings with check valves (6, FIG. 4) and that the valves (6) are hinged on one edge and have a rather small distance between the side with hinge and the opposite side and that the bearing profiles (21) straight across the frame are thin and broad and placed vertical in the walls and in the wave direction in the bottom (4).

5. Wave power device according to claim 1, characterized by that the device (FIGS. 7 and 8) are mounted floating in deep water in fixed height by at least one float (43) under water and at least 3 taunt anchor cables (44) from fastenings on the device, which have a certain mutual distance and which form the corners in a triangular without small angles, and approximate parallel to at least one anchor (46) below the device.

6. Wave power device according to claim 5, characterized by that the device (FIGS. 7 and 8) are mounted floating with 2 floats (43) under water with one by each side wall (2) and that the device has 4 anchor fastenings (50) near the corners with possible winches and that the taunt anchor cables (44) slope a bit together down to the fastening on the anchor (46) below the device and that the device has one anchor fastening (49) on each side of the device which can move opposite on their own rail (51) and that there goes from each anchor cable fastening (49) two anchor cables (45) which form a great angle between them to each of their own anchor (47).

7. Wave power device according to claim 5, mounted floating on deep water, characterized by that the device has at least 2 floats (33) below the device with a certain distance between them and at least 2 taunt anchor cables (32) from each floats (33) which are fastened near the ends of the floats (33) and which slope together to one anchor cable (31) a bit over the fastening on the anchor (30).

8. Wave power device which floats and can be turned against the waves according to claim 5, characterized by that the device has at least one wing (38, FIG. 9) with a horizontal axle (36) pointing to the centre of the device and that the wing (38) can freely turn around the axle (36) away from its horizontal position when the water moves up and down in the waves and that the wing can be activated for horizontal force by that the angle away from horizontal position is limited to working angle and that the device can be turned in opposite direction by that the wing system are turned 180 degree or the axle are replaced inside the wing after impulse from censor for wave direction.

9. Wave power device according to claim 8, characterized by that the device has at least two wings down in the water with one on each side of the device which are working against each other by that they will turn the device in opposite direction and is placed so that when the device is not facing correct against the waves the wing on the one side of the device comes in lee for the waves and loose force while the wing on the other side get increased power by that the waves comes slope in against the side of the device and get increased height.

10. Wave power device according to claim 1, characterized by that the outlet from the turbine are led to an outlet basin with fixed mounted devices and to an outlet chamber by floating devices and that they are drained through great areas with openings with check valves and are equipped with division walls covered with openings with check valves for streaming away from the turbine.

11. Wave power device according to claim 1, characterized by that the check valve (6) is made of a curved plate (61) where the two straight edges are fixed to two opposite side profiles (62) and (63) on a flat frame with tie bars (65) with possible cross walls (66) and that the valve body are fastened by the bars (64) to an axle (60) which is placed so that the curved valve plate (61) turns in or very near a circle path with same radius between stops for open and closed valve and that the closing force from the spring system (69) work on the bars (64) and that the valve has a spring system (71) by the edge profile (62) and alternative a spring system (72) by the edge profile (63) so that when the valve closes it stops with clearance to the valve seat before the pressure comes and move the valve to the seat and that the spring system (71) is compressible so that the curved valve plate (61) can get a slope position in relation to a circle path with the centre in the axle when the valve get pressure.

12. Wave power device according to claim 11, characterized by that more valves in a row can be mounted on the same through shaft (60) and that on the axle sits a spring system (70) with beforehand stressed spring which work on the bars (64) which fix the valve body to the axle (60) and that the valve (6) can open and be kept open by turning the axle (60) and that the spring system (70) prevent the opening of a valve under pressure.
